(19) United States
(12) Patent Application Publication
(10) Pub. No.: US 2008/0062704 A1
(43) Pub. Date: Mar. 13, 2008

(54) High uniformity diffuser lens structure

(76) Inventors: Yu-Wei Chang, Jhongli Industrial Park (TW); Jen-Huai Chang, Jhongli Industrial Park (TW); Wen-Feng Cheng, Jhongli Industrial Park (TW)

Correspondence Address: PRO-TECHTOR INTERNATIONAL SERVICES, 20775 NORADA CT., SARATOGA, CA, 95070, US

(21) Appl. No.: 11/518,349

(22) Filed: Sep. 8, 2006

(51) Int. Cl. F21V 5/00

(52) U.S. Cl. 362/330; 362/331; 362/339

(57) ABSTRACT

A high uniformity diffuser is provided, wherein a light emission surface of the diffuser is added with prismatic lenses, such that a passage of light is changed through refraction or reflection caused when the light of lamps passes through the lens, in order to achieve an effect of scattering the light.

### BACKGROUND OF THE INVENTION

a) Field of the Invention

The present invention relates to a high uniformity diffuser, and more particularly to a high uniformity diffuser wherein a plate surface is formed into a three-dimensional structure in different shape in order to change a passage of light in association with an addition of different diffusant, such that light emitted from a CCFL (Cold Cathode Fluorescent Lamp) is uniformly scattered, and an amount of CCFL to be used is reduced in a backlight module, thereby providing an effect of optical uniformity after the light comes out of a light emission surface.

b) Description of the Prior Art

As a popularity of digital televisions, a liquid crystal displayer has been highly emphasized and has been extensively growing in a competition of displayers in recent years. In imaging of liquid crystal displayer, frames to be displayed are driven by an on and off of electric field, and a liquid crystal panel itself will not emit light, whereas a backlight module should be used to provide a light source to the liquid crystal displayer. Ordinarily, the light source which is applied to the large-scale liquid crystal displayer is a direct type light source which can satisfy a requirement of the light source of high brightness and uniformity, by an addition of lamps and a design of diffusion elements. In order to satisfy the requirement of uniform light source, the direct type backlight module will use a diffuser as an essential element for uniformly emitting the light. The so-called diffuser is primarily used to diffuse the light, and by using a change of type and refraction rate of the added diffusant, the light can be repeatedly refracted between the diffusers to be uniformly distributed, so as to achieve a very good effect. However, although the diffusion efficiency of earlier products has met the requirement, they are no longer in compliance with the requirement of usage, under a trend toward environmental protection and low cost for the displayers. In recent years, as the cold cathode fluorescent lamp and power adapter are expensive, the quantity of use of the lamps is decreased and the diffusion elements are changed, in order to be in compliance with the requirement and to reduce the cost. Nevertheless, as the amount of use of the lamps is decreased, a gap between the lamps is increased, which results in a more severe non-uniformity of the brightness. Therefore, a higher diffusivity is required, and a large quantity of light diffusant is used in the diffuser. At this time, bright specks of the cold cathode fluorescent lamp cannot be uniformed by the diffuser, and its behavior of volume diffusion has not been able to satisfy this requirement, but only by changing the structure of diffuser or the backlight module that the requirements of high brightness and high diffusivity can be both satisfied.

On the other hand, the effect of light diffusion is primarily achieved by the light diffusant added into the diffuser or surface configuration of the diffuser. Therefore, adding a prismatic lens on a light emission surface of the diffuser has been one approach to increase the effect of light diffusion. However, although adding the prismatic lenses on the diffuser uniformly can reconfigure the light to achieve the effect of splitting, contribution to an effect of shading to the lamps is not significant. In a design of present invention, the lens structures in a triangular shape are added on the light emission surface, with each structure being corresponding to a position and design of the lamp, so as to achieve an effect of light scattering through a change of passage of the light from refraction or reflection induced when the light passes through the lenses. In addition, through an addition and distribution of the diffusant, incoming light can be uniformly diffused, in order to satisfy a requirement of fitting which is necessary for the backlight module. In the design of conventional diffuser, the increase of light diffusivity of diffuser has not been able to achieve a very good effect in terms of shading the lamps, and the brightness of entire backlight source will be decreased. In the present invention, a change of different angle and shape is implemented to the prismatic structures for the positions of lamps, which can uniform the light distribution, and can achieve a purpose of increasing the uniformity by using the added diffusant to shade the bright specks of lamps.

### SUMMARY OF THE INVENTION

The primary object of present invention is to provide a high uniformity diffuser wherein a passage of light in the diffuser is changed, such that a behavior of the light coming out of a light emission surface of the diffuser is changed, in association with using a prismatic design for a light source and other elements in a backlight module. The diffuser of the direct type backlight module is manufactured into a diffuser having plural surfaces of prismatic lens, to split incoming light to increase its uniformity. Angles of the light which emits toward each direction are adjusted through the installation of plural prismatic surfaces on the diffuser, so as to achieve an effect of reconfiguring the light source. The prismatic lens can be also designed according to a position and distance of lamps, with each orderly aligned prismatic lens being corresponding to a neighboring distance of cold cathode fluorescent lamp and a height between the diffusers, to be in compliance with the effect of prismatic lens design. In addition to the prismatic lens, surface at two sides of a plate are provided with a diffusant in proper amount at a same time, which will further scatter the light to make it uniform, thereby further shading or scattering bright specks of the lamps.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a schematic view of a lens of the present invention.

FIG. 1-1 shows a local exploded view of a lens of the present invention.

FIG. 2 shows a second schematic view of a lens of the present invention.

FIG. 2-1 shows a second local exploded view of a lens of the present invention.

FIG. 3 shows a third schematic view of a lens of the present invention.

FIG. 3-1 shows a third local exploded view of a lens of the present invention.

FIG. 4 shows a fourth schematic view of a lens of the present invention.

FIG. 4-1 shows a fourth local exploded view of a lens of the present invention.

### DETAILED DESCRIPTION OF THE PREFERRED EMBODIMENTS

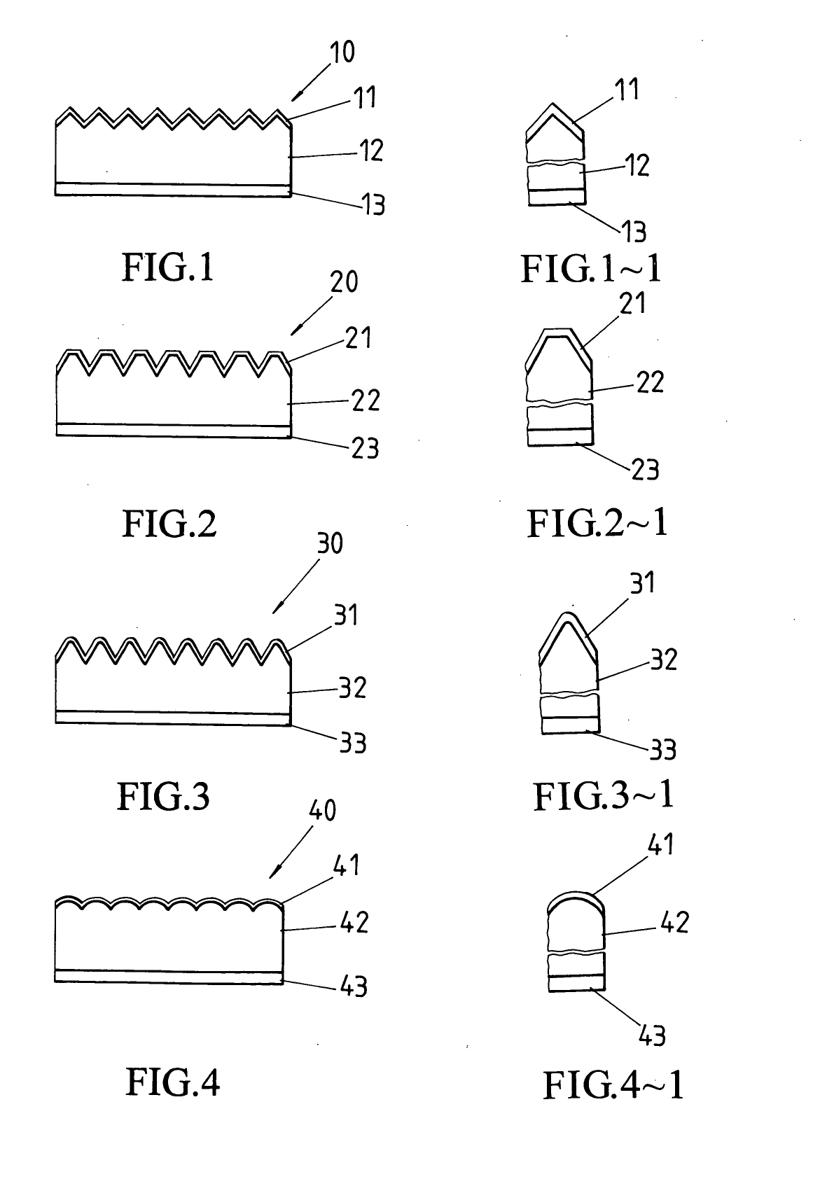

Referring to FIG. 1 and FIG. 1-1, a plate of light emission surface of a diffuser of the present invention is added with a prismatic lens structure 10 which includes upper, middle, and lower layers 11, 12, 13 that are assembled together by an extrusion die and then are formed into the prismatic shape through a forming roller. The upper layer 11 is a part made by a secondary extruder, the middle layer 12 is a part made by a primary extruder, and the lower layer 13 is a part made by a secondary extruder.

Referring to FIG. 2 and FIG. 2-1, a plate of light emission surface of a diffuser of the present invention is added with a trapezoidal lens structure 20 which includes upper, middle, and lower layers 21, 22, 23 that are assembled together by an extrusion die and then are formed into the trapezoidal shape through a forming roller. The upper layer 21 is a part made by a secondary extruder, the middle layer 22 is a part made by a primary extruder, and the lower layer 23 is a part made by a secondary extruder.

Referring to FIG. 3 and FIG. 3-1, a plate of light emission surface of a diffuser of the present invention is added with a prismatic lens structure having an arc-shape tip 30 which includes upper, middle, and lower layers 31, 32, 33 that are assembled together by an extrusion die and then are formed into the shape of prism with the arc-shape tip through a forming roller. The upper layer 31 is a part made by a secondary extruder, the middle layer 32 is a part made by a primary extruder, and the lower layer 33 is a part made by a secondary extruder.

Referring to FIG. 4 and FIG. 4-1, a plate of light emission surface of a diffuser of the present invention is added with an arc-shape lens structure 40 which includes upper, middle, and lower layers 41, 42, 43 that are assembled together by an extrusion die and then are formed into the arc-shape through a forming roller. The upper layer 41 is a part made by a secondary extruder, the middle layer 42 is a part made by a primary extruder, and the lower layer 43 is a part made by a secondary extruder.

The aforementioned lens structures 10, 20, 30, 40 can be a PMMA (Polymethylmethacrylate), MS (Monostyrene), PS (Polystyrene), or PC (Polycarbonate) material, wherein the light diffusant is only added into the upper layers 11, 21, 31, 41, or is only added into the lower layers 13, 23, 33, 43, or is only added into the middle layers 12, 22, 32, 42, or is added at a same time into the upper and middle layers 11, 12, 21, 22, 31, 32, 41, 42, or is added at a same time into the middle and lower layers 12, 13, 22, 23, 32, 33, 42, 43, or is added at a same time into the upper and lower layers 11, 13, 21, 23, 31, 33, 41, 43, or is added at a same time into the upper, middle, and lower layers 11, 12, 13, 21, 22, 23, 31, 32, 33, 41, 42, 43.

The aforementioned lens structures 10, 20, 30, 40 can be also added with an ultraviolet light absorbent, which can be only added into the upper layers 11, 21, 31, 41, or can be only added into the lower layers 13, 23, 33, 43, or can be only added into the middle layers 12, 22, 32, 42, or can be added at a same into the upper and middle layers 11, 12, 21, 22, 31, 32, 41, 42, or can be added at a same time into the middle and lower layers 12, 13, 22, 23, 32, 33, 42, 43, or can be added at a same time into the upper and lower layers 11, 13, 21, 23, 31, 33, 41, 43, or can be added at a same time into the upper, middle, and lower layers 11, 12, 13, 21, 22, 23, 31, 32, 33, 41, 42, 43.

In a practical application, the advantages of new design can be described below.

Due to environmental protection, high price for acquiring the cold cathode fluorescent lamp and the power adapter, and difficult in acquiring in the new design, the light can be reconfigured through the prismatic lenses to reduce the amount of use of the cold cathode fluorescent lamps, and the light can be scattered to achieve the uniformity by properly adding the light diffusant, so as to shade the non-uniformity of brightness caused by the enlargement of distance between the lamps. In terms of the plate to be extruded, the complexity in manufacturing will not be increased, thereby facilitating the production. Therefore, the new diffuser design is provided with the advantages of improving the function of diffuser and of lowering the cost.

For example, an EML (Electro-absorption Modulator Laser)—the diffuser having a light emission surface which is formed into the prismatic lenses—produced by the present inventor is compared with an EMS (Enhanced Message Service) product. The pitch of prismatic lenses is 0.4 mm, the angle of lens is 110°, the thickness of upper and lower layers is 0.1 mm, and the distance between the lamps is 30 mm. After the diffuser is formed and cut into a proper shape, it is emplaced at a backlight source of direct type cold cathode fluorescent lamp to proceed with the measurement and to compare the results.

In the new design, the passage of light can be adjusted through a change of angle and distribution of the prismatic lenses, and the flexibility of product will be better than that of the conventional product, through adjusting the amount of light diffusant to be added into the surface layers of plate. On the other hand, the diffusion effect of light diffusant is directionless, and manifests an irregular scattering effect. For the light of prismatic lenses, a different structure, shape, and angle can be designed, according to the distance between the lamps, the height from the diffuser, and the gap between the lamp and a reflection plate, in the backlight module. Therefore, in the design of displayers, more space is provided for a designer, such that products can be designed according to different requirements, to improve a utilization of the light.

Accordingly, in the present invention, the surface of plate is formed into the three-dimensional structure in different shape, in order to change the passage of light, along with an addition of different diffusant, such that the light emitted from the CCFL in the backlight module is uniformly scattered, and the amount of use of the cold cathode fluorescent lamps can be decreased, thereby achieving the effect of optical uniformity after the light comes out of the light emission surface.

It is of course to be understood that the embodiments described herein is merely illustrative of the principles of the invention and that a wide variety of modifications thereto may be effected by persons skilled in the art without departing from the spirit and scope of the invention as set forth in the following claims.

1. A high uniformity back light diffuser comprising:
a planar substantially transparent lower diffusing layer having a first major surface facing a backlight source and an opposing second major surface, said lower diffusing layer selectively containing a light diffusant, and an ultraviolet light absorbent, each in controllably variable concentrations;
a planar substantially transparent middle diffusing layer having a first major surface extrusion bonded to the second major surface of said lower layer and an opposing second major surface, said middle diffusing layer selectively containing a light diffusant, and an ultraviolet light absorbent, each in controllably variable concentrations;
a substantially transparent upper diffusing layer having a first major surface extrusion bonded to the second major surface of said middle layer, said upper diffusing layer selectively containing a light diffusant, and an ultraviolet light absorbent, each in controllably variable concentrations; and
a prismatic lens structure formed on an upper light emission major surface of the upper layer on the reverse of the back light diffuser from the backlight source;
wherein the geometry of the prismatic lens, and the concentrations of diffusant and ultraviolet absorber, may be adjusted according to the spacing between backlight sources to produce a uniformiy bright diffuse light emission.

2. The high uniformity back light diffuser according to claim 1, wherein the lens structure is in a trapezoidal shape.

3. The high uniformity back light diffuser according to claim 1, wherein the lens structure is in a prismatic shape with an arc-shape tip.

4. The high uniformity back light diffuser according to claim 1, wherein the lens structure is in an arc shape.

5. The high uniformity back light diffuser according to claim 1, wherein the upper layer is added with a light diffusant and an ultraviolet absorbent.

6. The high uniformity back light diffuser according to claim 1, wherein the lower layer is added with a light diffusant and an ultraviolet absorbent.

7. The high uniformity back light diffuser according to claim 1, wherein the upper and lower layers are added with a light diffusant and an ultraviolet absorbent.

8. The high uniformity back light diffuser according to claim 1, wherein the middle layer is added with a light diffusant and an ultraviolet absorbent.

9. The high uniformity back light diffuser according to claim 1, wherein the middle and lower layers are added with a light diffusant and an ultraviolet absorbent.

10. The high uniformity back light diffuser according to claim 1, wherein the upper and middle layers are added with a light diffusant and an ultraviolet absorbent.

11. The high uniformity back light diffuser according to claim 1, wherein the upper, middle, and lower layers are added with a light diffusant and an ultraviolet absorbent.

12. The high uniformity back light diffuser according to claim 1, wherein at least one diffusing layer of the diffuser is made of PMMA.

13. The high uniformity back light diffuser according to claim 1, wherein at least one diffusing layer of the diffuser is made of MS.

14. The high uniformity back light diffuser according to claim 1, wherein at least one diffusing layer of the diffuser is made of PS.

15. The high uniformity back light diffuser according to claim 1, wherein at least one diffusing layer of the diffuser is made of PC.
